(19) United States
(12) Patent Application Publication
(10) Pub. No.: US 2008/0099736 A1
(43) Pub. Date: May 1, 2008

(54) Fire retardant compositions and methods of use

(76) Inventors: Colin Edward Clarke, Narooma (AU); Ian Ronald Vandenbosch, Mornington (AU)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(21) Appl. No.: 11/786,240

(22) Filed: Apr. 11, 2007

(30) Foreign Application Priority Data
Oct. 11, 2004 (AU) AU 2004 905853
Oct. 11, 2005 (AU) PCT/AU2005/001576

(51) Int. Cl. C09K 21/00; C09K 3/00

(52) U.S. Cl. 252/607; 252/380; 252/601

(57) ABSTRACT

The present invention provides fire retardant compositions that have the further advantage of conferring resistance to insects, mould, mildew and fungus species. The composition includes a metal ion, a borate ion, and a borate ion-complexing species. Also provide are methods for producing a fire retardant composition as described in the specification.

### TECHNICAL FIELD

The present invention relates to compositions for treating materials such as wood and paper, and natural textiles to confer fire, mould, mildew, fungus and insect resistance. The compositions of this invention are relatively non-toxic and environmentally friendly.

### BACKGROUND TO THE INVENTION

Many materials useful for building and other industrial applications are flammable. This is particularly true of cellulosic materials, such as wood and wood products, paper and cardboard, and textiles from natural plant fibers. Since these materials have properties that are difficult to duplicate using non-flammable substitutes, much research has focused on how to make these materials less flammable.

Cellulose, such as in wood and paper, is a polysaccharide that burns by a complex oxidative mechanism when subjected to a temperature above about 140° C. The cascading sequence of oxidative reactions includes cleavage of the polysaccharide into its constituent monomers (glucose and glucose derivatives) and oxidative splitting of the glucose rings of the monomers. For example, an intermediate reaction product is levoglucosan which oxidizes further to volatile, flammable compounds and char. The char is believed to be comprised mainly of carbon together with mineral residues. Oxidative cleavages of the chemical bonds comprising the cellulose molecules release large amounts of chemical energy, chiefly in the form of heat and light. The heat produced is also a major factor that perpetuates the cascading progression of oxidative reactions until all the cellulose fuel is ultimately consumed.

A number of fire retardant compositions suitable for treating cellulosic materials are known in the art. The compositions are typically applied preventatively to the material for protection against fire.

Known fire retardants often include fertilizer grade ammonium polyphosphates. These can be corrosive, especially to metals such as aluminum. In an effort to address the corrosivity problems encountered with the use of fertilizer grade ammonium polyphosphates, sodium ferrocyanide was incorporated into the corrosive compositions. Sodium ferrocyanide has proven to be an effective corrosion inhibitor in fire retardant compositions containing ammonium polyphosphate fertilizer solutions. However, while sodium ferrocyanide is effective as a corrosion inhibitor, several disadvantages of its use make its incorporation in wildland fire retardant compositions undesirable. Specifically, the environmental and toxicological safety of ferro(i)cyanides is, at best, questionable.

Fertilisers and other phosphates have relatively low thermal decomposition temperatures and can produce toxic gases, as well as leaving a troublesome sticky residue or powder, and are now regarded as being potentially detrimental to the environment in that they are capable of promoting blue-green algae in waterways.

The prior art also discloses the use of halogens, and particularly chlorides, for the manufacture of fire retardants. However, given the problems of salinity in many regions of the world, the use of chlorides is contraindicated. The halogens have further disadvantages in respect of the environment as many can produce toxic gases that damage the earth's ozone layer.

Sulphates, sulphites, nitrates, and nitrites may also be used as fire retardants but can produce acidic or toxic gases or other noxious byproducts. Avoidance of such chemicals or compounds which may be considered unsuitable due to inherent toxicity properties, or which may produce other unsuitable products on thermal decomposition or chemical reaction on exposure to heat or flame, reduces the scope of available chemical compounds for potential use considerably.

Compositions that may be applied to timber in the building industry typically include phosphorus compounds such as monoammonium or diammonium phosphate. The phosphorus compounds are prepared as an aqueous composition, and applied to a cellulosic surface such as wood. Alternatively, the substrate material may be immersed in the composition. The solution is then allowed to dry on the material, leaving behind crystals of the phosphate salt on the surface. The main problem with this approach is that the phosphate salt is present only on the surface and is water soluble. Any subsequent wetting of the treated substrate material causes leaching of the salt, thereby decreasing the fire retardant properties of the material.

Another problem with the above approach is that free phosphate salts are dissociable into ions that can cause structural deterioration of the cellulose. Although such dissociation occurs rapidly in wet conditions, it will also occur on a “dry” surface, which normally has one or more layers of water molecules thereon that originated from the atmosphere. A cellulosic substrate derives a significant portion of its structural integrity by hydrogen bonding between adjacent cellulose molecules. These hydrogen bonds can be disrupted by the incursion of ions (electrostatically charged atomic or molecular species) between the atoms participating in the bonds, which interrupts the bonding interactions between the atoms and ultimately causes the cellulose molecules to separate from one another. Such damage allows penetration of water into and general destruction of the substrate.

Free phosphate salts and low molecular-weight acids, such as phosphoric acid, can also cause delignification of wood by reacting with and cleaving lignins that bind wood fibers together and by cleavage of the cellulose molecules comprising the wood. Such cleavage can ultimately result in a potentially severe loss of structural strength of the wood, especially over a prolonged period of time.

Many cellulosic materials can be degraded or even destroyed by living organisms such as insects, or microorganisms such as mould and fungi. Materials of a biological origin such as wood, paper, and cotton are especially vulnerable. As deficiency of prior art fire retardants is that they do not provide significant resistance to these additional environmental factors. Where the prior art has provided compositions suitable for conferring resistance to insects and microorganisms, the compositions are environmentally unfriendly and may even be dangerous. For example, timber produced for external weather exposed applications is often treated with preservatives to protect from fungal decay and rot, and attack from wood-borers and termites. A variety of chemical formulations for this purpose are known such as Creosote, Copper-Chrome-Arsenic (CCA), and Ammoniacal-Copper-Quaternary (ACQ). These formulations are toxic to humans and other animals, and exposure of these materials to fire can produce toxic and poisonous gases. In addition, community concerns regarding the leaching of such chemicals into the environment, particularly Arsenic, has led to legislative actions prohibiting further use of CCA. However, these do nothing for fire retardancy.

Finally, given that fire retardants may be used in large volumes, it will be appreciated that many compositions are economically unattractive.

It is an aspect of the present invention to overcome or alleviate a problem of the prior art by providing a composition that is useful in protecting materials from environmental factors such as fire, insects and microorganisms that is relatively environmentally friendly and economical.

### SUMMARY OF THE INVENTION

In one aspect the present invention provides a composition for conferring fire retardancy on a material, the composition comprising a borate ion, a borate ion-complexing species, and a metal ion. Applicants have found that when the borate ion-complexing species forms an ionic complex with the borate it is possible to include the borate at higher than expected concentrations. The presence of metal ions in the composition in combination with the high concentrations of borate leads to compositions having unexpectedly high levels of fire retardancy. It has also been found that the composition affords resistance to insects such as termites and borers, as well as microorganisms such as fungi.

A preferred borate is potassium tetraborate, and a preferred metal ion is potassium.

The borate-ion complexing species preferably includes at least one available hydroxyl radical, and more preferably includes only carbon, hydrogen and oxygen atoms. In exemplary embodiments of the invention the borate ion-complexing species is an acetic, citric, or tartaric acids, or a carbohydrate such as starch or an acetate, or a combination of any of these compounds.

Advantageously, the compositions of the present invention are compatible with binders and sealants, thereby broadening their use to nonabsorbent materials. The use of binders and sealants also inhibits the leaching of actives from the treated material.

Also provided by the present invention is a method for treating a material to confer resistance to an environmental factor comprising use a composition as described herein. The method may be applied to any suitable material, but is preferably applied to a cellulose-based material such as wood, paper, cardboard, a natural fiber, or an insulation material.

The invention yet further provides a method for producing a fire retardant composition as described herein, the method comprising providing a borate ion-complexing species in aqueous solution and then adding a borate ion to the solution. Where the final composition is includes an acetate ion, the method includes providing an acetate ion in aqueous solution, then adding to the solution a borate ion-complexing species, and then adding a borate ion to the solution.

Still further, the present invention provides a material treated by a method as described herein.

### BRIEF DESCRIPTION OF THE FIGURES

FIGS. 1 to 6 show the results of six separate cone calorimetry experiments using timber treated with a composition comprising 20% (w/v) potassium tartrate, 20% (w/v) potassium tetraborate (anhydrous), 16% (w/v) potassium acetate, all dissolved in water. pH was adjusted to 7.5, and final specific gravity was 1.4. Panel A, specific extinction area (m²/kg); Panel B, heat release rate (kW/m²), Panel C carbon dioxide production (g/s); Panel D, carbon monoxide production (g/s); Panel E, effective heat of combustion (MJ/kg); Panel F, extinction coefficient (1/m); Panel G, mass (g); Panel H, mass loss rate (g/s); Panel I, rate of smoke release ([m²/s]/m²); Panel J, total heat released (MJ/m²); Panel K, total smoke release (m²1 m²); Panel L, smoke production rate (m²/s). The X-axis is time (s).

### DETAILED DESCRIPTION OF THE INVENTION

In a first aspect the present invention provides a composition for treating a material, the composition comprising a borate ion, a borate-ion complexing species, and a metal ion. Applicants have found that an aqueous solution comprising high concentrations of borate are useful in the treatment of many materials, and particularly cellulosic materials. The compositions are useful primarily as a fire retardant for materials such as wood, paper and natural fibers such as cotton, but in addition are further proposed to confer resistance to living organisms such as mould, fungus, mildew and termites.

Without wishing to be limited by theory, it is thought that the borate-complexing species forms an ionic complex with the borate, allowing for higher borate concentrations than those normally achievable in aqueous solution. The high concentrations of borate ion enables complex formation with cellulose which facilitates penetration of the composition (including fire retardant metal ions) into the material. The metal ion is responsible for forming an initial intumescent barrier layer of carbon-metal oxide at the surface and subsurface of the treated material during combustion. This barrier layer substantially inhibits the spread of combustion. Also provided during formation of the barrier layer is the production of carbon dioxide and water, which of course are fire retardant in their own rights. The adsorbed components (i.e. the mixture of component ions adsorbed to the material), provide further heat and/or flame protection thereby acting as a thermal barrier. The organic anions are thought to progressively and rapidly decompose under the action of applied heat up to about 500-600° C. to progressively form the respective metal oxide and carbon barrier layer. The depth of the barrier increases as the temperature increases, and so the more heat that is applied the more the adsorbed mixture component ions react to the heat. This heat-mediated reaction is thought to be modified or augmented by the presence of complexed borate of which has a far higher decomposition temperature, so full decomposition of the mixture components will not occur until well above 800° C. Above that temperature (and including temperature up to the melting range of steel) the barrier further develops providing greater fire retardancy.

The metal ion may originate form any source, and may be provided as part of a borate salt, or part of any other salt added to the composition. The skilled person will understand that the minimum level of metal ion in the composition required to confer a given level of fire retardancy on the treated material will vary according to the metal ion, or mixture of metal ions included. For example, where the metal is aluminium a lower concentration will be necessary than if the metal is Zinc. The reason is that aluminium oxide (Al₂O₃) as formed on the treated material when exposed to heat has greater heat refractory properties than zinc oxide (ZnO). A composition containing potassium as the metal ion would require a higher concentration of the metal than would be necessary for Zinc to achieve a similar level of fire retardancy because potassium oxide (K₂O) is less refractive to heat than zinc oxide.

As a guide only, the minimum levels of fire retardancy for timber specified by Australian Standard 3959 would require application of a composition according to the invention comprising a potassium ion concentration of at least about 10% by weight, where the potassium ion is provided as the acetate salt. This equates to a concentration of at least about 1 mole per liter (i.e. about 1 M).

The skilled person is adequately enabled to assess the level of a certain metal ion, or any combination of metal ions for their ability to provide heat refractory metal oxides on the treated material, thereby conferring fire retardancy. For example cone calorimetry may be used to assess the compositions of the present invention. The cone calorimeter is a fire test instrument based on the principle of oxygen consumption calorimetry. This empirical principle is based on the observation that, generally, the net heat of combustion of any organic material is directly related to the amount of oxygen required for combustion. Approximately 13.1 MJ of heat are released per kilogram of oxygen consumed. The cone calorimeter is a device used to burn small samples of various materials and gather data on heat release, combustion products, and other parameters associated with combustion.

At the core of the instrument is a radiant electrical heater in the shape of a truncated cone (hence the name). This heating element irradiates a flat horizontal sample, 100×100 mm and up to 50 mm thick, placed beneath it, at a preset heating flux of up to 100 kW/m². The sample is placed on a load cell for continuous monitoring of its mass as it burns. Ignition is provided by an intermittent spark igniter located about 13 mm above the sample.

The gas stream containing the combined combustion products is captured through an exhaust duct system, consisting of a high-temperature centrifugal fan, a hood, and an orifice-plate flowmeter. The typical air flow rate is 0.024 m³/sec. Oxygen concentration in the exhaust stream is measured with an oxygen analyzer capable of an accuracy of 50 ppm., and the heat release rate is determined by comparing the oxygen concentration with the value obtained when no sample is burning. All data are collected with a PC, which records data continuously at fixed intervals of a few seconds while a test is being conducted.

The cone calorimeter is used to determine the following principal fire properties: rate of heat release per unit area, cumulative heat released, effective heat of combustion, time to ignition, mass loss rate, and total mass loss, as well as smoke obscuration.

The composition includes a borate ion, and more particularly a tetraborate ion. The tetraborate is preferred because of a lower attractiveness to insects, and also provides for higher levels of fire retardancy. Depending on the species, borates are typically of low solubility (about 25 to 50 g/l). Inclusion of the borate-ion complexing species in the composition allows for borate concentrations much greater than that otherwise achievable. Thus, in one form of the composition the borate concentration is in excess of that normally achievable. The maximum achievable borate concentration is dictated by the borate ion-complexing species used in the composition, of which more is discussed infra. Suffice to mention at this point that different complexing species will have different numbers of available hydroxyl radicals for the borate to bond with, and in the case of long chain molecules such as carbohydrates the preferential Carbon atom sites. For example, where the borate ion-complexing species is acetate, 2 acetate ions are necessary per borate ion. In comparison, 1 tartrate ion is capable of complexing with 2 borate ions.

Applicants have shown that the borate solubility in a 59% acetate solution to be in excess of about 200 g/l, above which it becomes practically difficult to work with as it sets solid (albeit water soluble). In respect of Tartrate, the practical maximum has been found to be about 300 g/l.

Preferably, the concentration of the borate is between about 25 g/l and about 300 g/l. More preferably, the concentration of borate is between about 50 g/l and about 200 g/l.

As used herein, the term “borate ion-complexing species” includes any atom or compound capable of forming an ionic complex with a borate ion in aqueous solution, with the result that solubility of borate in the solution is improved.

It would be expected that many charged compounds capable of displacing water molecules and coordinating with the borate ion will be useful as a borate ion-complexing species. However, in a preferred form of the composition the borate-ion complexing species has at least one available hydroxyl radical.

While many borate ion-complexing species will be considered suitable for use in the present compositions, considerations of toxicity and cost will play a role in determining those most suitable for use as a component of a fire retardant composition. Least toxic species will include compounds that contain only carbon, hydrogen and oxygen atoms, such that toxic combustion products are not formed during fire. Furthermore, compounds that are attractive to insects and other destructive organisms are preferably avoided. In light of these considerations, Applicants have determined that organic acids and derivative salts thereof are particularly preferred as a borate ion-complexing species. Exemplary organic acids include acetic, tartaric, lactic, malic, formic, oxalic, and ascorbic acids. In a highly preferred form of the composition the borate ion-complexing species is chosen from acetetic, citratric, and tartaric acids.

The borate-complexing species may also be a carbohydrate. Preferably the carbohydrate is not one that is attractive to insects such as simple sugars including sucrose, glucose, fructose and the like. While the borate component of the composition is toxic to many insects, the insect may still cause significant damage before the adverse effects of the borate are evident. Complex carbohydrates such as starch are preferred because they are less attractive to insects and are still capable of increasing the solubility of the borate. A disadvantage of using starch as a borate ion-complexing species is the necessity to apply energy in some form, usually heat, to enable solubilisation by causing the granules to burst and release the soluble amylose portion from the amylopectin. This disadvantage of starch can be avoided in respect of the formulations of this invention by first dissolving the starch in an alkali-lye solution which produces a clear transparent yellow alkaline starch solution. The alkaline starch solution is then reacted with the boric acid thereby enabling the starch-complexed tetraborate to be produced as a clear transparent liquid at borate solution strengths of up to about 40%. While theory suggests that boric acid to starch ratios of up to 3:1 may be required, ratios of up to 10:1 or better be attained using this approach.

Preferably, the borate-complexing species is added to a concentration such that the concentration of the borate in the composition is capable of being between about 25 g/l and about 300 g/l. More preferably the borate-complexing species is added to a concentration such that the concentration of borate in the composition is capable of being between about 50 g/l and about 200 g/l.

The borate ion may be included in the composition by any means known to the skilled artisan, including by the addition of boric acid or any salt of boric acid to water. The skilled person will understand that by routine experimentation it will be possible to screen for borates that are useful in the context of the present invention. However, preferred borates include tetraborates. Preferably the borates are used as an alkali metal salt, and more preferably the metal is a Group 1A metal. In a highly preferred form of the composition, the Group 1A metal is potassium.

Potassium tetraborate may be produced from boric acid, solubility=50 gm/l, in the fundamental equation:

4H₃BO₃+2KOH=K₂B₄O₇+7H₂O.

It should be noted that the tetraborate can be converted to the metaborate in accordance with the following equation:

M₂B₄O₇+2MOH=4MBO₂+H₂O,

where M=Na, K etc.,
and the formation of metaborate in the context of this invention is undesirable as it can cause fire. Again accounting for the solubility of KOH and enabling aqueous reaction the above fundamental equation becomes:

4H₃BO₃+2KOH+6H₂O=K₂B₄O₇ +13H₂O.

It is proposed that boric acid, and borates, are able to form ionic complexes with available hydroxyl radicals:

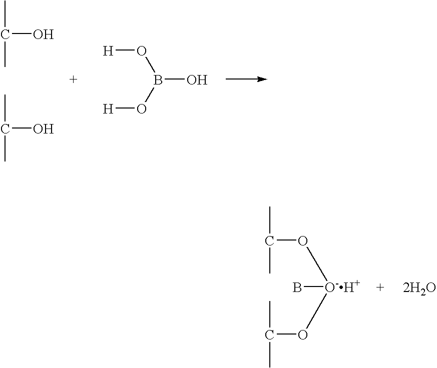

However, on mixing boric acid into a potassium acetate solution as shown above, the solubility of boric acid in water (50 gm/l) is able to be well exceeded (in excess of 200 gm/l) in such a mixture and this indicates that complexing occurs. Theory indicates that this would occur with the formation of 2KOH in the ionic solution, however, the pH reduces and that indicates that the KOH generated is immediately neutralised by the boric acid to the tetraborate, and a translucent gel forms as the solubility limit of the acetate-borate complex is approached, and the formed complex gel is highly water soluble. The acetate-borate complexing provides a unique and useful combination of properties for aqueous fire retardant compositions. However, the available hydroxyl radicals from the acetate anions is limited in respect of the ratio of acetate to borate and this in turn limits the amount of borate complexing that can occur which limits the borate concentration levels in the composition product. To achieve higher levels of borate in the formulations to provide more effective composition products requires further complexing with other suitable complementary compounds that are able to provide higher ratios of hydroxyl radicals for complexing with the borate anion.

The borate ion-complexing species may be an acetate ion. The acetate ion may be included by any means known to the skilled artisan, including by the addition of acetic acid or any salt of acetic acid to water. The skilled person will understand that by routine experimentation it will be possible to screen for acetates that are useful in the context of the present invention. Preferably the acetate is in the form of an alkali metal salt, and more preferably the metal is a Group 1A metal. In a highly preferred form of the composition, the Group 1A metal is potassium. Potassium acetate may be produced from the fundamental equation:

CH₃COOH+KOH=CH₃COOK+H₂O

Acetic acid, CH₃COOH, has a molecular weight of 60.054, Melting Point 16° C. and Flash Point 39° C. The Glacial acid is corrosive with hazardous fumes. It should be stored and used in a constant temperature environment, and should be pumped into the caustic alkali KOH at a slow rate with efficient mixing to maintain a controlled reaction temperature. The hazardous fumes can be avoided using this approach, and by fitting the acid storage containers with airlocks for pressure equalisation during pumping and prevention of fumes. The reaction vessel should be stainless steel of suitable grade.

Potassium hydroxide, KOH, has a molecular weight of 56.108, its solubility in water is 1120 gram/litre and it dissolves in water with the evolution of considerable heat (Heat of Solution). This solubility in water approximates 18KOH:50H₂O on a molecular weight basis. In practical terms the above fundamental equation becomes:

18CH₃COOH+18KOH+50H₂O=18CH₃COOK+68H₂O

1080.972+1009.944+900.8=1766.628+1225.088=2991.716

59%+41%=100%

It is anticipated that one or a combination of two or more borate ion-complexing species may be used in the inventive compositions. For example, in a particularly preferred form of the composition a carbohydrate such as starch, and a Group 1A alkali metal tartrate are used to complex the borate ion. Another example includes the use of starch and a Group 1A metal citrate.

In highly preferred forms of the invention, the fire retardant compositions are generally exemplified by the following preferred approximate ranges of proportions, expressed as percentages by weight.

| | |
|---|---|
| Alkali-metal acetate | 5-40 |
| Alkali-metal tetraborate | 5-30 |
| Other borate complexing species | 5-30 |

The balance of the composition is water and any other ingredients, including binders or sealants as required. Indeed, a particular advantage of the inventive compositions described herein is their compatibility with binders and/or sealants. This allows for the incorporation of a binder and/or sealant into the compositions, or for a binder or sealant to be applied to the treated material after application of the composition. The prior art compositions have compatibility problems with binders and sealants which is overcome or alleviated by compositions described herein.

Applicants have determined that acetate compounds exhibit useful properties of fire-retardancy, are fungicidal and resistant to mould and mildew, and are resistant to wood-borers and termites. The acetates, in contrast to other anions such as carbonate, bicarbonate, and citrate, have been found to be more compatible with water-based polymeric binders/sealants. Their application has, however, been somewhat limited as a general purpose fire-retardant or extinguishant due to their relatively low decomposition temperatures but can be considered useful in rapid formation of an intumescent barrier layer. The alkali-metal carbonates and bicarbonates, despite their other attributes, have been found to be incompatible with water-based polymeric sealants and binders.

Binders and sealants prevent or retard the permeation of a liquid on, in, or through a substrate material, or the leaching of a fire retardant composition of this invention from the treated material. A problem with many fire retardants of the prior art is that exposure of the treated material to water results in leaching of an essential component of the applied composition. This leaching may result from exposure to rain or humidity and will lead to a gradual decrease in fire resistance over time.

A variety of binders and sealants are known to the skilled person, with many being routinely used in the paint industry. Water-based polymers are now extensively used in paint formulations typically at proportions of from about 30% to about 60%, and are also used as clear lacquers. Modern day paints are also typically formulated to include high levels of insoluble oxides in suspension such as Titanium dioxide, fillers or extenders such as clay or whiting, and also include rheological modifiers and other additional chemicals to provide fungicidal and mildewicidal properties to the paint formulation. As such, modern day paints of this type can be considered to be inherently fire retarded, although not to the same degree as the compositions described herein. It is the polymer in the paint formulation that acts as the binder or sealant and which cures on drying to form the resultant paint film or coating. However, water-based polymer lacquers which cure on drying to form a clear coating or film as available in the marketplace are not generally fire-retarded. Suitable binders for use in the present invention are the acrylic polymer binders manufactured by materials companies such as Rohm & Haas (Philadelphia), or equivalents thereof. As used herein, the term “equivalent” is intended to mean a product having similar physical and chemical properties such that similar results are achieved in the context of the invention.

Research into water-based polymers typically used in paint and lacquer formulations, such as for example, the Rohm & Haas Primal AC-2235, PR-3230, and the like, indicates that such polymers are readily cured in dry air, or exposure to heat, or contact with various anions such as carbonates, bicarbonates, or citrates. The ability of such polymers to be air or heat cured enables their use in timber treatment processes to take advantage of their bonding properties whereby the timber is impregnated or coated with a composition containing a water-based polymer and a compatible water soluble fire retardant formulation in accordance with this invention to provide on drying and curing a timber treated product having the properties of being fire-retarded and preserved against fungal decay and rot and attack by borers and termites, and which is moisture and leach resistant, and which does not degrade the structural stability of the timber.

A particularly preferred acrylic polymer is Primal AC-2235 or equivalents thereof. The binder and/or sealant may be present in the composition from a ratio of from about 1:10 to a ratio of about 10:1 (vol:vol).

In one embodiment of the composition, a dendrimer is used as a sealant. The dendrimer may be readily emulsifiable by an anionic dispersant (such as Ricaphob P1640) or a cationic dispersant (such as Ricaphob EEE). Both Ricaphob EEE and Ricaphob P1640 are supplied by RCA International Pty Ltd (3 Pilgrim Court, Ringwood 3134 Victoria, Australia). Other suitable dendrimers are found in published PCT patent specification WO/2003/078725 and U.S. Patent Application 20050085573 (both to RUDOLF GMBH & CO. KG CHEMISCHE FABRIK).

The dendrimer may be used in any amount necessary to achieve desirable binding and/or sealing, and may be used from a ratio of from about 1:10 to a ratio of about 10:1.

The composition may also comprise a gum, such as xantham gum to minimise separation of components. Typically, the gum is included in low amounts, such as from about 1% (wt/wt) to about 5% (wt/wt).

In another aspect the present invention provides a method for treating a material comprising use a composition described herein. While much of the disclosure herein is directed to cellulose-based materials such as wood, paper, cardboard, natural fibers such as cotton, insulation materials, and the like. It is emphasized that other materials may be treated with the inventive compositions to confer fire retardancy and resistance to certain environmental factors. For example, due to the relatively non-toxic nature of the composition it may be applied directly to a human or animal on fire, or at risk of being on fire.

The material may be non-organic, and may even be non-absorbent. Where non-absorbent materials are treated it is contemplated that a binder and/or sealant will be included in the composition to prevent active components of the composition being lost from the treated material.

The nature of the material will likely influence the manner in which the composition is applied to the material. The material may be treated by any suitable method including painting, spraying, rolling, soaking, vacuum impregnation, and the like. It is important to note that the method is not limited to any particular method of application. Preferably the method of treatment affords the material improved resistance to an environmental factor selected from the group consisting of fire, heat, combustion, an insect (including termites or borers), a mould, a mildew, and a fungus.

Also provided by the present invention is a material treated by a method described herein. The material preferably displays improved resistance to an environmental factor selected from the group consisting of fire, heat, combustion, an insect (including termites or borers), a mould, a mildew, and a fungus.

It will be understood that improved resistance is intended to mean resistance of the treated material as compared with the untreated material. There is no requirement for the resistance to be complete. Furthermore, the resistance may be in respect of one or more of any of the environmental factors listed. Preferably the resistance is in respect of fire and insects in combination.

Yet a further aspect of the present invention provides a method for producing a fire retardant composition described herein, the method comprising providing a borate ion-complexing species in aqueous solution and then adding a borate ion to the solution.

Where the final composition is designed to include an acetate ion, the method includes providing an acetate ion in aqueous solution, then adding to the solution a borate-ion complexing species, and then adding a borate ion to the solution.

The present invention will now be further described by reference to the following non-limiting examples

### EXAMPLES

### Example 1

### Production of Composition Comprising Potassium Tetraborate, Potassium Acetate, and Dipotassium Citrate.

7CH₃COOH+7KOH+21 H₂O=7CH₃COOK+28H₂O

400 gm of KOH is added to 380 gm of water and mixed until dissolved, allowed to cool below 50° C., and acetic acid added slowly to about pH 8 to 9. This produces about 1200 gm of potassium acetate solution at about 58% strength. 990 gm of boric acid is then added and mixed to form a slurry.

16H₃BO₃+8KOH+24H₂O+(C₆H₁₀O₅)ₙ=4K₂B₄O₇−(C₆H₁₀O₅)ₙ complex+52H₂O

450 gm of KOH is added to 433 gm of water and mixed until dissolved. 100 gm of starch is then added and mixed. A turbid yellow mixture results which gradually clarifies to a clear transparent yellow solution. The alkaline starch mixture is then added slowly while mixing to the potassium acetate and boric acid slurry. The resultant complexed solution mixture of about 300 gms contains about 30% potassium tetraborate and 22% potassium acetate. The pH of the resultant solution may be adjusted with further quantities of potassium hydroxide or acetic acid as desired.

Citric acid is a tribasic acid and is able to form three series of salts, and in the context of this invention, the di-alkali metal salt is preferred in the compositions of this invention in respect of the formation of near-neutral compositions. Dipotassium citrate may be produced from citric acid in the fundamental equation:

C₆H₈O₇+2KOH=K₂C₆H₆O₇+2H₂O+Heat

In practical terms, accounting for the solubility of KOH in water, the fundamental equation becomes:

C₆H₈O₇+2KOH+6H₂O=K₂C₆H₆O₇+8H₂O

In simplified form, combining boric acid with citric acid in aqueous reaction with caustic alkali:

4H₃BO₃+C₆H₈O₇+4KOH+12H₂O=K₂B₄O₇+K₂C₆H₆O₇+21H₂O

### Example 2

### Larger Scale Production of Composition Comprising Potassium Tetraborate, Potassium Aacetate, and Dipotassium Citrate.

1010 gm of flaked potassium hydroxide is added to and dissolved in 900 gm of water with stirring. When the temperature has reduced to below 50° C., acetic acid is added slowly until the pH is about 8 to 9. As shown in the above equation, this results in about 3000 gm of potassium acetate solution at about 59% strength.

To this solution is then added, while stirring, about 1540 gm of citric acid, and about 1980 gm of boric acid, resulting in a slurry and enabling the boric acid to complex with the potassium acetate and the citric acid. About 1800 gm of flaked potassium hydroxide is added to and dissolved in about 1830 gm of water, while stirring. This alkali solution is then added slowly with stirring to the slurry mixture until reaction is complete. The solution pH can be adjusted with KOH, or acetic or citric acid as desired. The resultant complexed solution mixture is about 19% potassium tetraborate, 21% dipotassium citrate, 18% potassium acetate, and 42% water. The resultant mixture proportions as illustrated in this example may be easily varied by varying the relevant equations factorially as required.

### Example 3

### Composition Replacing Citrate with Tartrate.

While mixtures as illustrated by Example 2 have less than desired compatibility with some non-ionic water-based polymers in consequence to the inclusion of the citrate ion, other types of polymeric binders have not yet been evaluated for compatibility, but such mixtures as illustrated above provide effective non-toxic fire retardant compositions for general and other purpose applications where the use of binders or sealants is not required.

Where the inclusion of binders or sealants is desired, citrate may be replaced with tartrate. Dipotassium tartrate may be produced from tartaric acid in the fundamental equation:

C₄H₆O₆+2KOH=K₂C₄H₄O₆+2H₂O,

This equation is in fact a 2-step process wherein potassium hydrogen tartrate is formed as an intermediate product:

C₄H₆O₆+KOH=KHC₄O₆H₄+H₂O

and,

KHC₄O₆H₄+KOH=K₂C₄O₆H₄+H₂O

It should be noted that the solubility of dipotassium tartrate is 2000 gram/litre whereas the solubility of potassium hydrogen tartrate is 5.7 gram/litre.

Accounting for the solubility requirements of KOH, the above equation becomes:

4C₄H₆O₆+8KOH+24H₂O=4K₂B₄O₇+32H₂O.

In simplified form, combining boric acid with tartaric acid in aqueous reaction with Caustic alkali:

4C₄H₆O₆+4H₃BO₃+10KOH+30H₂O=(4K₂C₄H₄O₆+K₂B₄O₇) complex+45 H₂O

In the above reaction equation, the potassium tetraborate ratio is about 12% of the reaction product mix and this ratio can be varied, for example,

4C₄H₆O₆+16H₃BO₃+16KOH+48H₂O=(4K₂C₄H₄O₆+4K₂B₄O₇) complex +84H₂0

and in this equation the potassium tetraborate component is increased to about 28% of the total reaction product mix.

1515 gm of flaked potassium hydroxide is added to 1350 gm of water while stirring, and when cooled to below 50° C., is reacted with acetic acid to pH 8 to 9. The resultant solution is about 4.45 kg of potassium acetate at about 59% strength. To this solution is added 2.4 kg of Tartaric acid, and 3.96 kg of boric acid, while stirring, to form a slurry and enable complexing of the boric acid with the potassium acetate and tartaric acid.

3.59 kg of flaked potassium hydroxide is dissolved in 3.5 kg of water, stirred and allowed to cool. This alkali solution is then added slowly to the slurry mixture while stirring until reaction is complete. The resultant complexed solution mixture is about 10% potassium acetate, 22% dipotassium tetraborate, 21% dipotassium tartrate, and 47% water. The resultant mixture proportions as illustrated in this example may be easily varied by varying the relevant equations factorially as required.

In practical terms, to produce compositions in accordance with this invention, certain factors may be considered. The reactions with caustic alkali lye are highly exothermic and can be violent, particularly when hot. Addition of boric acid to a liquid can form hard solid lumps which are difficult to break-up and dissolve, and this can be minimised or avoided by first producing the aqueous potassium acetate as indicated above, adding the additional complexing agent to form a liquid slurry, and then slowly adding the boric acid to the slurry to enable the complexing to occur. In addition, tetraborate can be converted to the metaborate with excess alkali and this can be avoided by ensuring that the required molecular ratio amount of alkali is added slowly to the boric acid/complex with efficient mixing so that the boric acid/complex is always in excess of the alkali.

### Example 4

### Production of Composition Including Acrylic Polymer.

Fire retardant compositions as illustrated above are able to be combined with compatible binders or sealants, of which the acrylic polymer binders manufactured by Rohm & Haas are typical of those used in paint formulations. As indicated above, such paint formulations may comprise from about 30% to about 60% acrylic polymer, but varies according to the properties of a given polymer and the application requirements.

Compatibility tests were conducted with the Rohm & Haas acrylic polymer, Primal AC-2235, with fire retardant compositions as illustrated in Example 3, and compatibility within the combined mixtures was established from the ratio of 1:10 to the ratio 10:1. The combined mixtures were sealed in airtight containers and checked at weekly intervals for 3 months with no indication of coagulation or other changes. The mixtures were then applied to untreated pine sample pieces measuring 100 mm×100 mm×19 mm, allowed to dry and cure at 22° C. and 50% Relative Humidity. Each sample exhibited penetration of the mixture within the timber, and preliminary tests show resistance to subsequent moisture penetration under the action of pressurised water with no apparent or significant reduction in fire retardancy properties for a given mixture ratio.

### Example 5

### Production of Composition Including Dendrimer.

Compatibility was established with a hydrocarbon dendrimer manufactured by RCA International Pty Ltd, RICAPHOB EEE. A fire retardant composition as illustrated in Example 3 was mixed with the dendrimer in the ratio of 10:1. The combined mixture was subsequently applied to untreated pine sample boards and oven dried.

Saw cuts were made across the sample boards at varying depths. Preliminary water tests show resistance to moisture penetration as the applied water formed beads on the sample boards with no detectable penetration at the surface or in the saw cuts. Further preliminary tests showed no significant reduction in fire retardancy of the sample boards treated with the combined mixture.

### Example 6

### Cone Calorimetry of Treated Timber

Six samples of timber were treated with a composition as described in Example 3 herein. (i.e. approximately 20% Potassium Tartrate, 20% Potassium Tetraborate, 16% Potassium Acetate, and 44% water, correlating to the total combined equation which produces about 13 litres of composition weighing about 18 kg, Specific Gravity=1.4, at pH 7.5, viz,

16C₄O₆H₆+64H₃BO₃+30CH₃COOH+94KOH+276H₂O=16K₂C₄O₆H₄+16K₂B₄O₇+30CH₃COOK+448H₂O

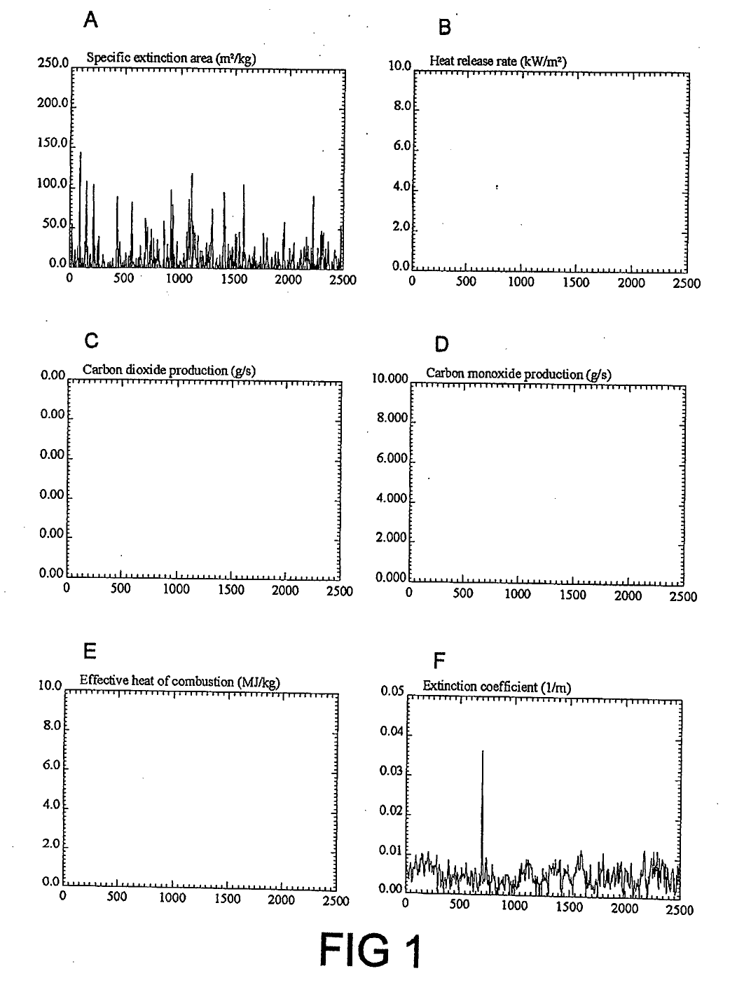

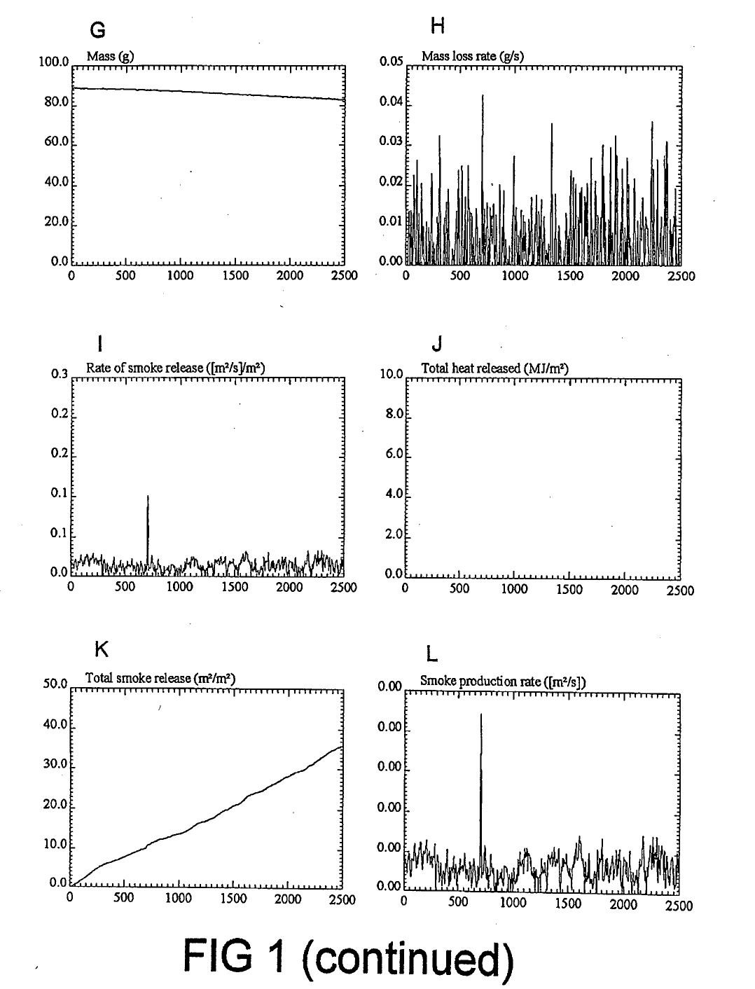

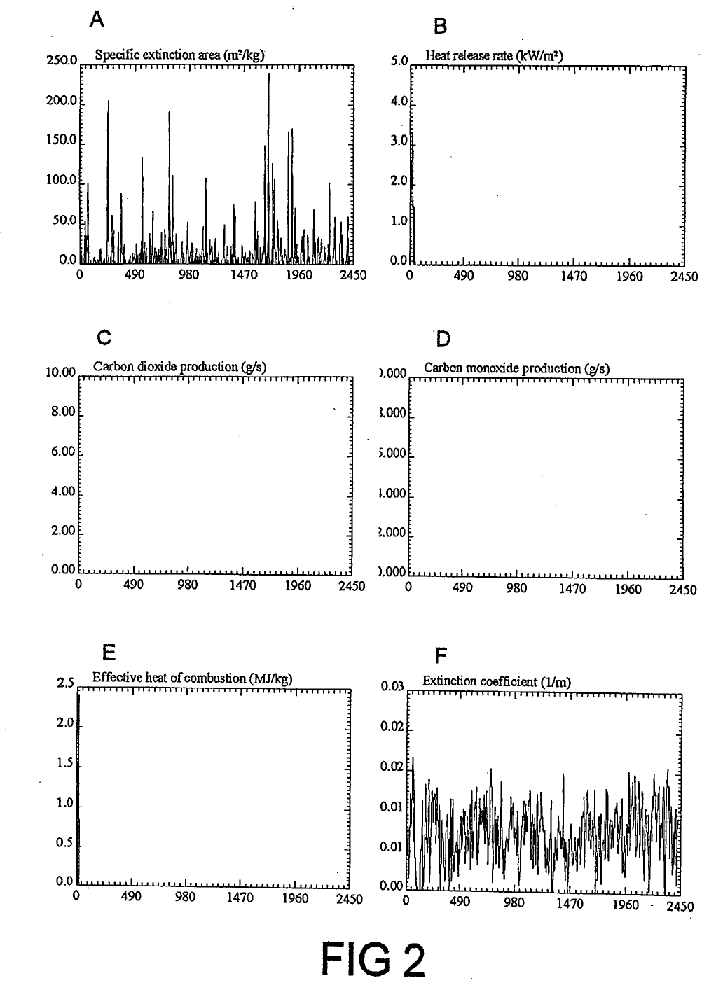

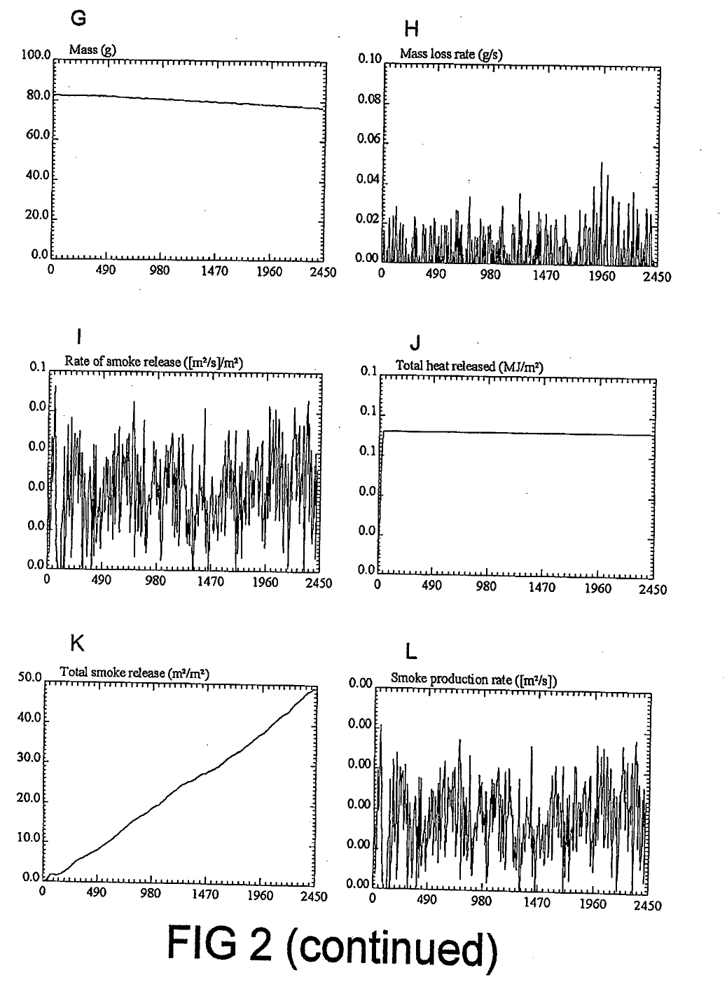

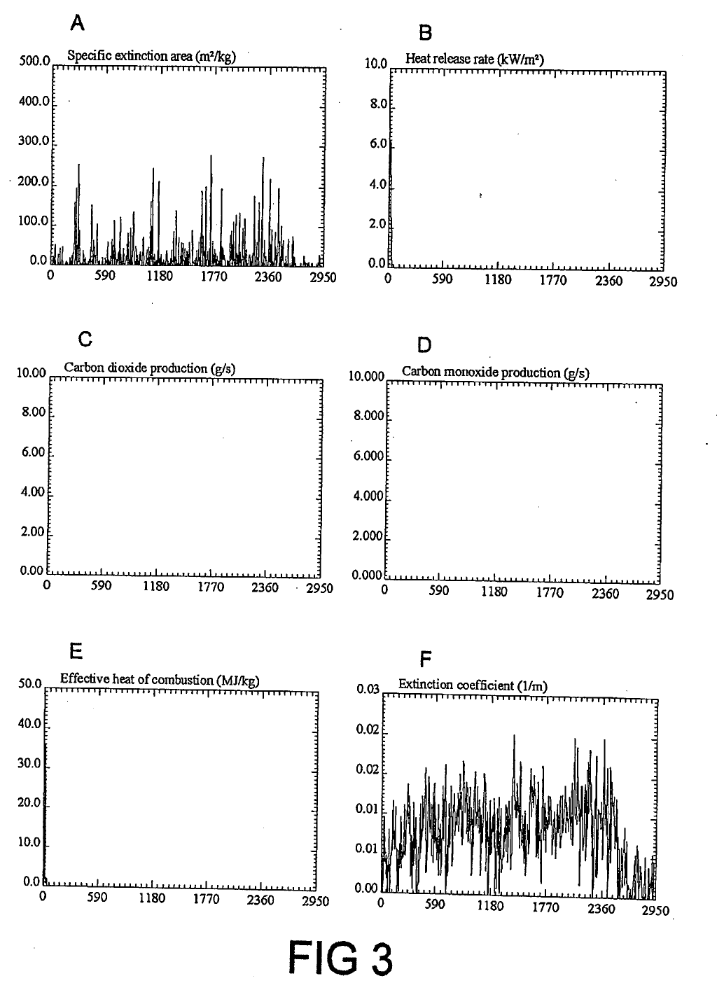

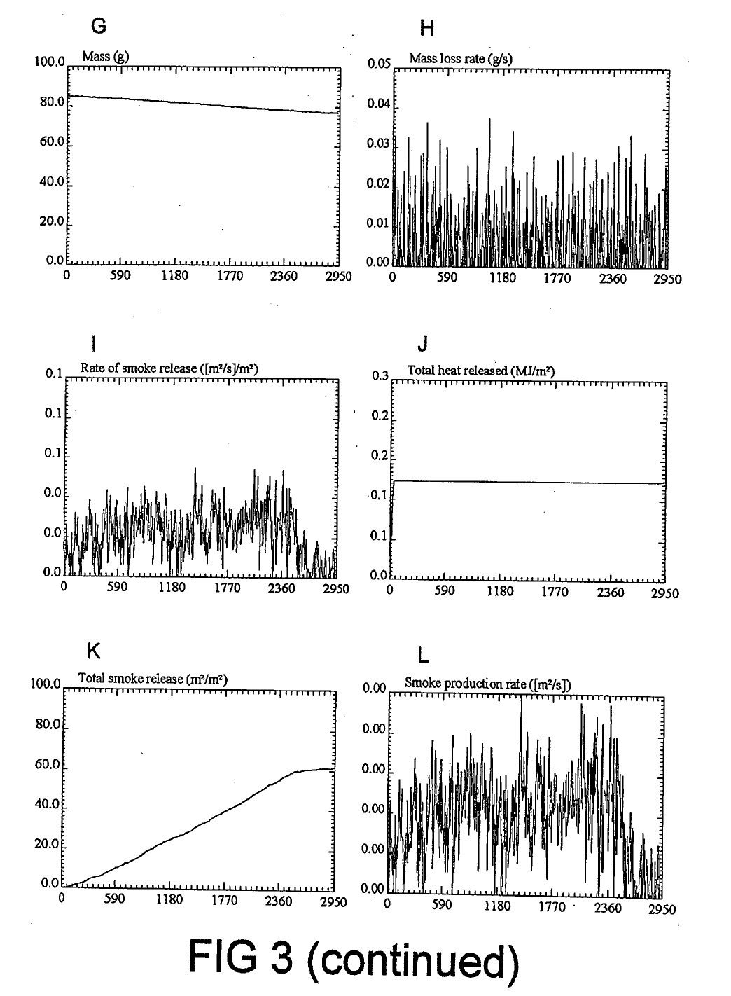

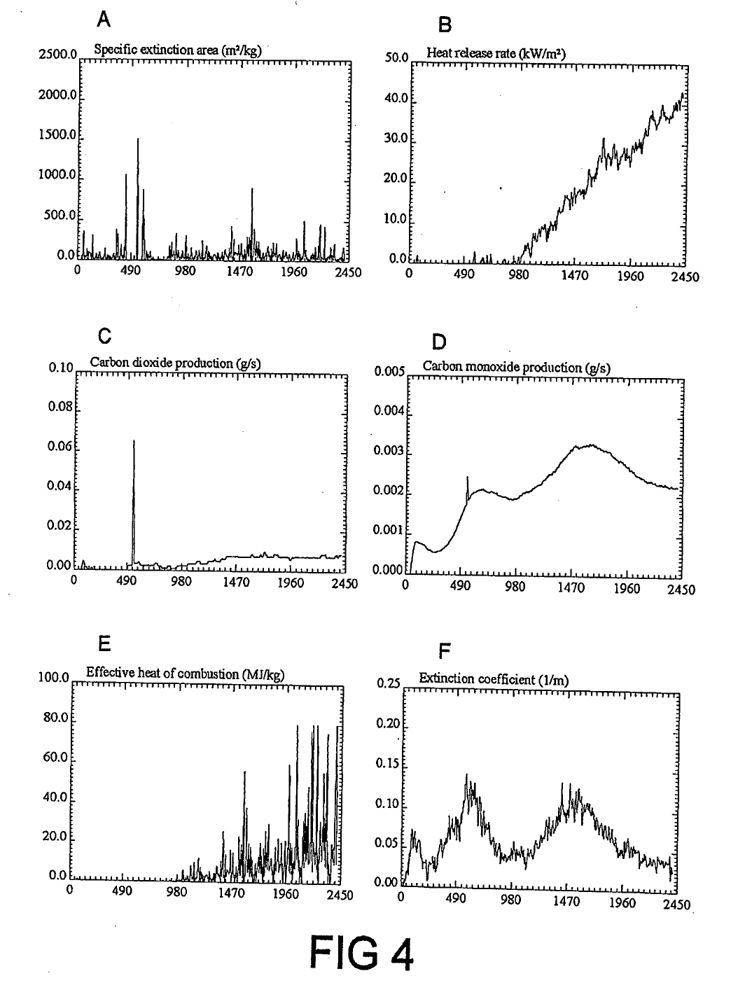

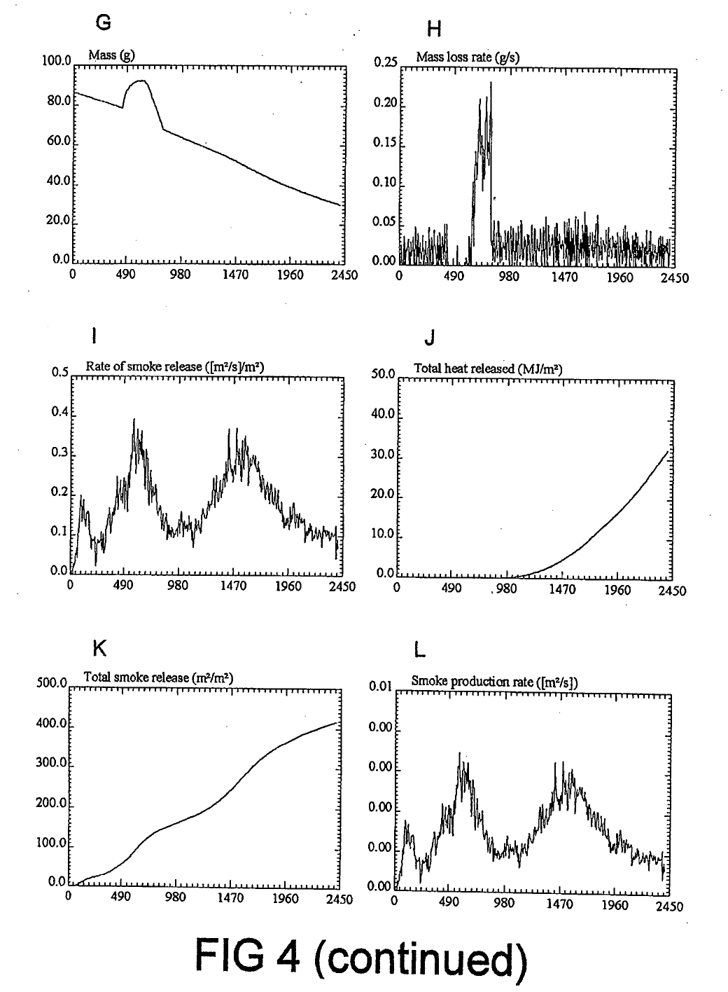

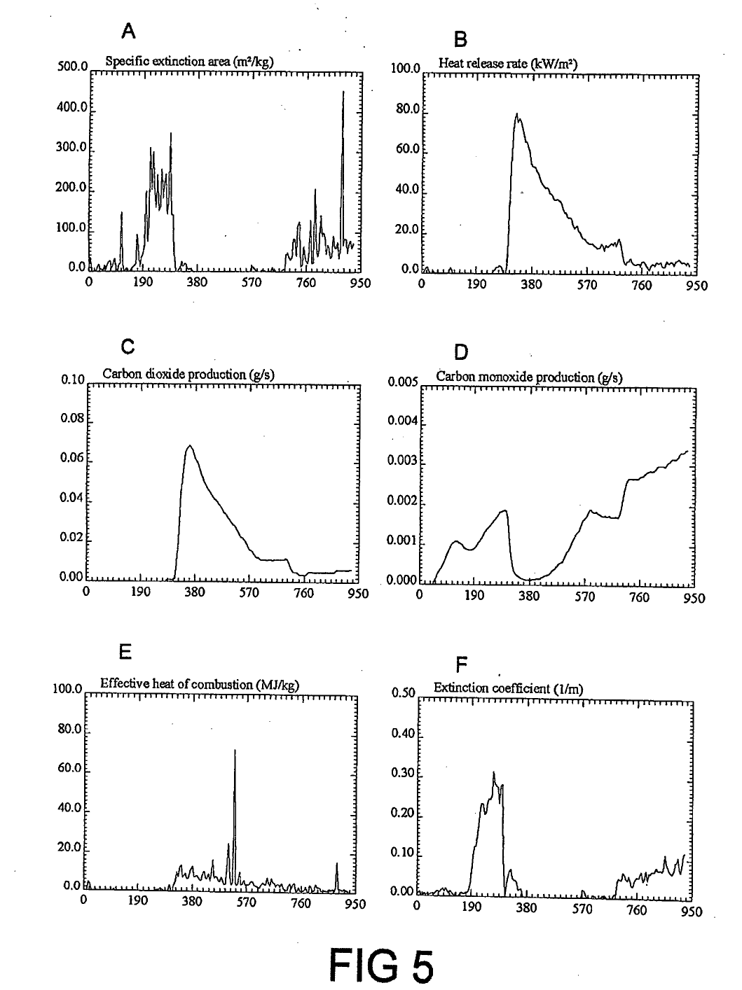

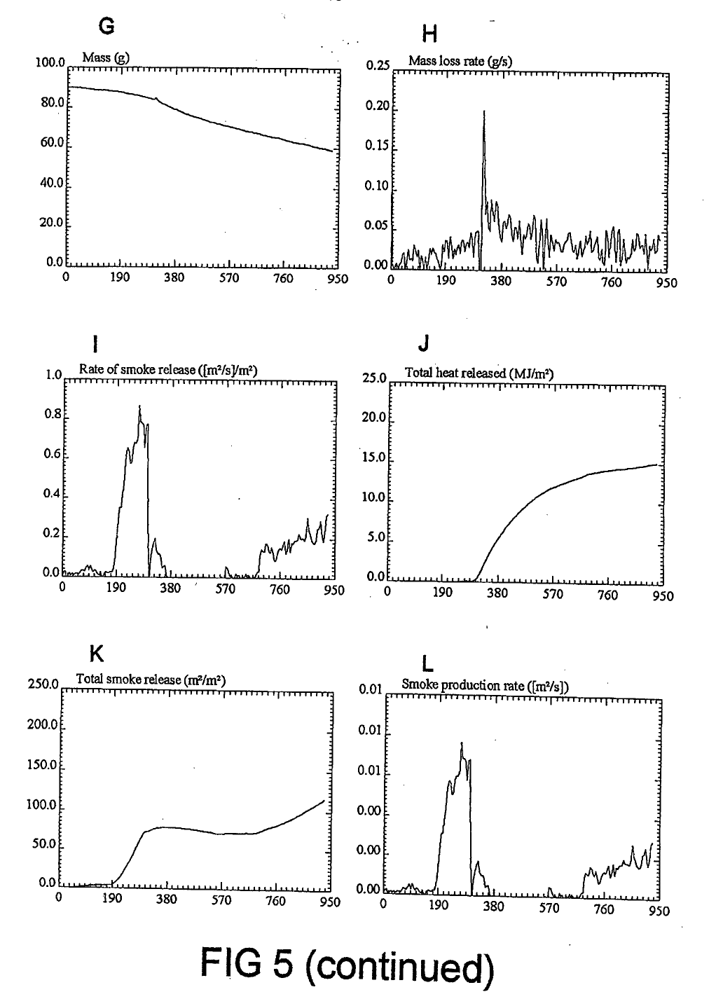

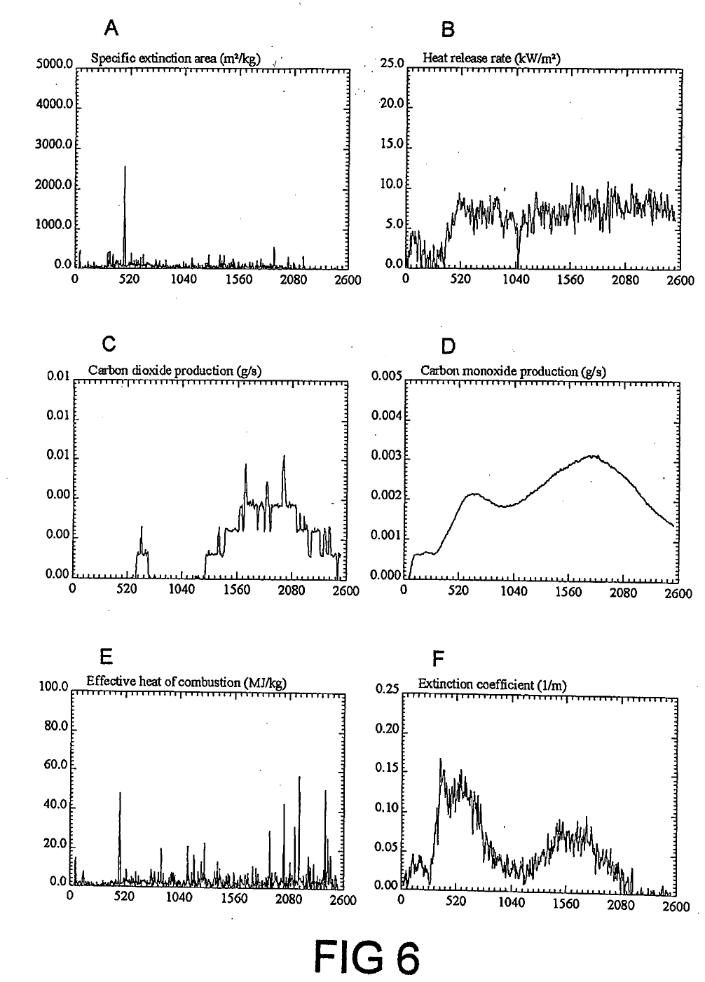

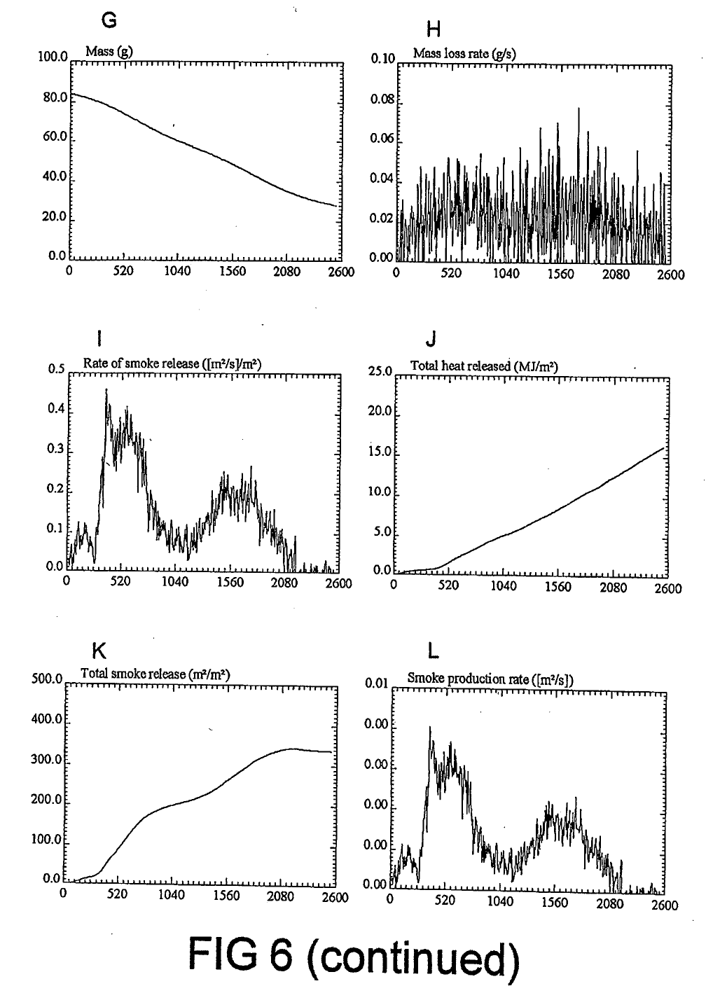

The output of the cone calorimeter is shown for each sample in Tables 1 to 6 below, and in FIGS. 1 to 6.

TABLE 1

| Material name | Pyronil | | |
|---|---|---|---|
| Sample description | Sample 11 | | |
| File name | Pyronil | | |
| Date of test | Thursday, Aug. 18, 2005 | | |
| Specimen thickness | 19.00 mm | | |
| Specimen surface area | 88.4 cm² | | |
| Specimen initial mass | 88.80 g | | |
| Heat flux | 10.00 kW/m² | | |
| Exhaust duct flow rate | 24.00 l/s | | |
| Orientation | Horizontal | | |
| C factor | 0.041420 | | |
| Time to ignition | 0 secs | | |
| Flameout | 0 secs | | |
| End of test (for calculation) | 130 secs | | |
| End of test criterion | ISO 5660 | | |
| Total heat evolved | 0.0 MJ/m² | | |
| Total oxygen consumed | −0.4 g | | |
| Total Smoke Released | 2.2 m²/m² | | |
| Mass lost | 0.1 g | | |
| Average specific mass loss rate | 0.05 g/[m²s] | | |
| Run Notes | Tested treated side up. Tested with foil and frame. | | |
| Comment | | | |
| At 9 secs | Surface of specimen blackened | | |
| Peak and average values | Average | Peak | at Time(s) |
| Heat release rate (kW/m²) | 0.00 | 0.00 | 0 |
| Effective heat of combustion (MJ/kg) | 0.00 | 0.00 | 0 |
| Mass loss rate (g/s) | 0.000 | 0.026 | 100 |
| Specific extinction area (m²/kg) | 231.89 | 144.19 | 95 |
| Carbon monoxide yield (kg/kg) | −0.1236 | 0.0000 | 0 |
| Carbon dioxide yield (kg/kg) | −5.00 | 0.00 | 0 |

| Average during period | | | | | | |
|---|---|---|---|---|---|---|
| from ignition to ignition plus:- | 1 min | 2 min | 3 min | 4 min | 5 min | 6 min |
| Heat release rate (kW/m²) | 0.0 | 0.0 | 0.0 | 0.0 | 0.0 | 0.0 |
| Effective heat of combustion (MJ/kg) | 0.0 | 0.0 | 0.0 | 0.0 | 0.0 | 0.0 |
| Mass loss rate (g/s) | −0.002 | 0.001 | 0.001 | 0.001 | 0.001 | 0.001 |
| Specific extinction area (m²/kg) | 0.0 | 112.7 | 111.8 | 116.3 | 250.2 | 232.3 |
| Carbon monoxide yield (kg/kg) | 0.0000 | −0.0605 | −0.0551 | −0.0525 | −0.1101 | −0.1043 |
| Carbon dioxide yield (kg/kg) | 0.00 | −2.41 | −2.36 | −2.41 | −5.34 | −5.45 |

TABLE 2

| Material name | Pyronil | | |
|---|---|---|---|
| Sample description | Sample 12 | | |
| File name | Sample 12 | | |
| Date of test | Thursday, Aug. 18, 2005 | | |
| Specimen thickness | 19.00 mm | | |
| Specimen surface area | 88.4 cm² | | |
| Specimen initial mass | 82.50 g | | |
| Heat flux | 10.00 kW/m² | | |
| Exhaust duct flow rate | 24.00 l/s | | |
| Orientation | Horizontal | | |
| C factor | 0.041420 | | |
| Time to ignition | 0 secs | | |
| Flameout | 0 secs | | |
| End of test (for calculation) | 125 secs | | |
| End of test criterion | ISO 5660 | | |
| Total heat evolved | 0.1 MJ/m² | | |
| Total oxygen consumed | −0.1 g | | |
| Total Smoke Released | 1.6 m²/m² | | |
| Mass lost | 0.1 g | | |
| Average specific mass loss rate | 0.15 g/[m²s] | | |
| Run Notes | Tested treated side up. Tested with foil and frame. | | |
| Comment | | | |
| At 19 secs | Specimen surface blackened | | |
| Peak and average values | Average | Peak | at Time(s) |
| Heat release rate (kW/m²) | 0.58 | 3.26 | 20 |
| Effective heat of combustion (MJ/kg) | 5.12 | 2.40 | 15 |
| Mass loss rate (g/s) | 0.001 | 0.024 | 100 |
| Specific extinction area (m²/kg) | 112.71 | 100.80 | 75 |
| Carbon monoxide yield (kg/kg) | −0.1211 | 0.0000 | 0 |
| Carbon dioxide yield (kg/kg) | −3.36 | 0.00 | 0 |

| Average during period | | | | | | |
|---|---|---|---|---|---|---|
| from ignition to ignition plus:- | 1 min | 2 min | 3 min | 4 min | 5 min | 6 min |
| Heat release rate (kW/m²) | 1.2 | 0.6 | 0.4 | 0.3 | 0.2 | 0.2 |
| Effective heat of combustion (MJ/kg) | 0.0 | 13.5 | 4.0 | 3.3 | 1.6 | 2.9 |
| Mass loss rate (g/s) | −0.002 | 0.001 | 0.001 | 0.001 | 0.001 | 0.001 |
| Specific extinction area (m²/kg) | 0.0 | 308.5 | 133.7 | 171.2 | 116.3 | 251.3 |
| Carbon monoxide yield (kg/kg) | 0.0000 | −0.3063 | −0.1335 | −0.1418 | −0.0824 | −0.1842 |
| Carbon dioxide yield (kg/kg) | 0.00 | −8.43 | −4.29 | −5.21 | −3.23 | −7.48 |

TABLE 3

| Material name | Pyronil | | |
|---|---|---|---|
| Sample description | Sample 13 | | |
| File name | Sample 13 | | |
| Date of test | Thursday, Aug. 18, 2005 | | |
| Specimen thickness | 19.00 mm | | |
| Specimen surface area | 88.4 cm² | | |
| Specimen initial mass | 84.40 g | | |
| Heat flux | 10.00 kW/m² | | |
| Exhaust duct flow rate | 24.00 l/s | | |
| Orientation | Horizontal | | |
| C factor | 0.041420 | | |
| Time to ignition | 0 secs | | |
| Flameout | 0 secs | | |
| End of test (for calculation) | 85 secs | | |
| End of test criterion | ISO 5660 | | |
| Total heat evolved | 0.1 MJ/m² | | |
| Total oxygen consumed | 0.0 g | | |
| Total Smoke Released | 0.7 m²/m² | | |
| Mass lost | −0.6 g | | |
| Average specific mass loss rate | −0.83 g/[m²s] | | |
| Run Notes | Tested treated side up. Tested with foil and frame. | | |
| Comment | | | |
| At 25 secs | Specimen surface blackened | | |
| Peak and average values | Average | Peak | at Time(s) |
| Heat release rate (kW/m²) | 1.45 | 6.39 | 15 |
| Effective heat of combustion (MJ/kg) | 0.00 | 35.96 | 15 |
| Mass loss rate (g/s) | −0.007 | 0.033 | 25 |
| Specific extinction area (m²/kg) | 0.00 | 52.36 | 50 |
| Carbon monoxide yield (kg/kg) | 0.0000 | 0.0000 | 0 |
| Carbon dioxide yield (kg/kg) | 0.00 | 0.00 | 0 |

| Average during period | | | | | | |
|---|---|---|---|---|---|---|
| from ignition to ignition plus:- | 1 min | 2 min | 3 min | 4 min | 5 min | 6 min |
| Heat release rate (kW/m²) | 2.1 | 1.0 | 0.7 | 0.5 | 0.4 | 0.3 |
| Effective heat of combustion (MJ/kg) | 0.0 | 0.0 | 0.0 | 0.0 | 0.0 | 128.1 |
| Mass loss rate (g/s) | −0.010 | −0.006 | −0.003 | −0.001 | −0.001 | −0.000 |
| Specific extinction area (m²/kg) | 0.0 | 0.0 | 0.0 | 0.0 | 0.0 | 5539.4 |
| Carbon monoxide yield (kg/kg) | 0.0000 | 0.0000 | 0.0000 | 0.0000 | 0.0000 | −5.8256 |
| Carbon dioxide yield (kg/kg) | 0.00 | 0.00 | 0.00 | 0.00 | 0.00 | −238.09 |

TABLE 4

| Material name | Pyronil | | |
|---|---|---|---|
| Sample description | Sample 14 | | |
| File name | Sample 14 | | |
| Date of test | Thursday, Aug. 18, 2005 | | |
| Specimen thickness | 19.00 mm | | |
| Specimen surface area | 88.4 cm² | | |
| Specimen initial mass | 85.80 g | | |
| Heat flux | 25.00 kW/m² | | |
| Exhaust duct flow rate | 24.00 l/s | | |
| Orientation | Horizontal | | |
| C factor | 0.041420 | | |
| Time to ignition | 0 secs | | |
| Flameout | 0 secs | | |
| End of test (for calculation) | 75 secs | | |
| End of test criterion | ISO 5660 | | |
| Total heat evolved | 0.0 MJ/m² | | |
| Total oxygen consumed | −0.1 g | | |
| Total Smoke Released | 2.4 m²/m² | | |
| Mass lost | 0.7 g | | |
| Average specific mass loss rate | 1.05 g/[m²s] | | |
| Run Notes | Tested treated side up. Tested with foil and frame. | | |
| Comment | | | |
| At 17 secs | Specimen surface blackened | | |
| At 438 secs | Red glowing cracks in surface | | |
| Peak and average values | Average | Peak | at Time(s) |
| Heat release rate (kW/m²) | 0.15 | 1.24 | 70 |
| Effective heat of combustion (MJ/kg) | 0.15 | 0.62 | 70 |
| Mass loss rate (g/s) | 0.009 | 0.037 | 45 |
| Specific extinction area (m²/kg) | 32.51 | 358.50 | 55 |
| Carbon monoxide yield (kg/kg) | 0.0138 | 0.2577 | 55 |
| Carbon dioxide yield (kg/kg) | −0.48 | 0.00 | 0 |

| Average during period | | | | | | |
|---|---|---|---|---|---|---|
| from ignition to ignition plus:- | 1 min | 2 min | 3 min | 4 min | 5 min | 6 min |
| Heat release rate (kW/m²) | 0.0 | 0.1 | 0.1 | 0.1 | 0.1 | 0.0 |
| Effective heat of combustion (MJ/kg) | 0.0 | 0.1 | 0.1 | 0.0 | 0.0 | 0.0 |
| Mass loss rate (g/s) | 0.007 | 0.012 | 0.014 | 0.015 | 0.015 | 0.015 |
| Specific extinction area (m²/kg) | 29.8 | 57.1 | 64.4 | 58.0 | 53.3 | 55.7 |
| Carbon monoxide yield (kg/kg) | 0.0014 | 0.0304 | 0.0359 | 0.0363 | 0.0350 | 0.0366 |
| Carbon dioxide yield (kg/kg) | −0.79 | −0.14 | −0.07 | −0.08 | −0.10 | −0.12 |

TABLE 5

| Material name | Pyronil | | |
|---|---|---|---|
| Sample description | Sample 15 | | |
| File name | Sample 15 | | |
| Date of test | Thursday, Aug. 18, 2005 | | |
| Specimen thickness | 19.00 mm | | |
| Specimen surface area | 88.4 cm² | | |
| Specimen initial mass | 90.20 g | | |
| Heat flux | 25.00 kW/m² | | |
| Exhaust duct flow rate | 24.00 l/s | | |
| Orientation | Horizontal | | |
| C factor | 0.041420 | | |
| Time to ignition | 299 secs | | |
| Flameout | 691 secs | | |
| End of test (for calculation) | 925 secs | | |
| End of test criterion | ISO 5660 | | |
| Total heat evolved | 15.1 MJ/m² | | |
| Total oxygen consumed | 11.6 g | | |
| Total Smoke Released | 116.3 m²/m² | | |
| Mass lost | 31.0 g | | |
| Average specific mass loss rate | 4.50 g/[m²s] | | |
| Run Notes | Tested treated side up. Tested with foil and frame. | | |
| Comment | | | |
| At 32 secs | Specimen surface blackened | | |
| At 197 secs | Red glowing cracks on surface | | |
| At 332 secs | Black deep cracks on surface | | |
| Peak and average values | Average | Peak | at Time(s) |
| Heat release rate (kW/m²) | 23.78 | 80.22 | 325 |
| Effective heat of combustion (MJ/kg) | 5.27 | 72.20 | 525 |
| Mass loss rate (g/s) | 0.040 | 0.201 | 315 |
| Specific extinction area (m²/kg) | 15.76 | 451.55 | 885 |
| Carbon monoxide yield (kg/kg) | 0.0422 | 0.8218 | 885 |
| Carbon dioxide yield (kg/kg) | 0.53 | 9.36 | 525 |

| Average during period | | | | | | |
|---|---|---|---|---|---|---|
| from ignition to ignition plus:- | 1 min | 2 min | 3 min | 4 min | 5 min | 6 min |
| Heat release rate (kW/m²) | 67.8 | 60.4 | 53.4 | 46.9 | 40.8 | 36.4 |
| Effective heat of combustion (MJ/kg) | 9.3 | 8.7 | 8.4 | 7.8 | 7.4 | 7.0 |
| Mass loss rate (g/s) | 0.064 | 0.061 | 0.056 | 0.053 | 0.049 | 0.046 |
| Specific extinction area (m²/kg) | 15.2 | 7.3 | 3.2 | 0.1 | 0.0 | 0.2 |
| Carbon monoxide yield (kg/kg) | 0.0089 | 0.0059 | 0.0063 | 0.0092 | 0.0148 | 0.0195 |
| Carbon dioxide yield (kg/kg) | 0.59 | 0.78 | 0.81 | 0.78 | 0.75 | 0.70 |

TABLE 6

| Material name | Pyronil | | |
|---|---|---|---|
| Sample description | Sample 16 | | |
| File name | Sample 16 | | |
| Date of test | Thursday, Aug. 18, 2005 | | |
| Specimen thickness | 19.00 mm | | |
| Specimen surface area | 88.4 cm² | | |
| Specimen initial mass | 84.00 g | | |
| Heat flux | 25.00 kW/m² | | |
| Exhaust duct flow rate | 24.00 l/s | | |
| Orientation | Horizontal | | |
| C factor | 0.041420 | | |
| Time to ignition | 0 secs | | |
| Flameout | 0 secs | | |
| End of test (for calculation) | 60 secs | | |
| End of test criterion | ISO 5660 | | |
| Total heat evolved | 0.1 MJ/m² | | |
| Total oxygen consumed | 0.1 g | | |
| Total Smoke Released | 1.9 m²/m² | | |
| Mass lost | 0.6 g | | |
| Average specific mass loss rate | 1.14 g/[m²s] | | |
| Run Notes | Tested treated side up. Tested with foil and frame. | | |
| Comment | | | |
| At 28 secs | Specimen surface blackened | | |
| At 281 secs | Red glowing cracks in specimen surface | | |
| Peak and average values | Average | Peak | at Time(s) |
| Heat release rate (kW/m²) | 1.88 | 4.28 | 45 |
| Effective heat of combustion (MJ/kg) | 1.65 | 14.78 | 50 |
| Mass loss rate (g/s) | 0.010 | 0.061 | 0 |
| Specific extinction area (m²/kg) | 27.23 | 452.86 | 50 |
| Carbon monoxide yield (kg/kg) | −0.0063 | 0.0024 | 55 |
| Carbon dioxide yield (kg/kg) | −0.86 | 0.00 | 0 |

| Average during period | | | | | | |
|---|---|---|---|---|---|---|
| from ignition to ignition plus:- | 1 min | 2 min | 3 min | 4 min | 5 min | 6 min |
| Heat release rate (kW/m²) | 1.9 | 2.6 | 2.6 | 2.2 | 1.9 | 1.9 |
| Effective heat of combustion (MJ/kg) | 1.6 | 2.2 | 1.8 | 1.4 | 1.1 | 1.0 |
| Mass loss rate (g/s) | 0.010 | 0.011 | 0.013 | 0.015 | 0.015 | 0.017 |
| Specific extinction area (m²/kg) | 27.2 | 41.8 | 42.8 | 40.6 | 39.1 | 48.2 |
| Carbon monoxide yield (kg/kg) | −0.0063 | 0.0197 | 0.0270 | 0.0296 | 0.0314 | 0.0307 |
| Carbon dioxide yield (kg/kg) | −0.86 | −0.67 | −0.50 | −0.42 | −0.39 | −0.34 |

Samples 11-13 establish compliance to AS3959 Section 1.5.6(a) as required in that no ignition occurred when tested at 10 kW/m2, for all of the 3 samples. Samples 14-16 establish compliance to AS3959 Section 1.5.6(b) as required in that the maximum heat release rate does not exceed 100 kW/m2, and, the average for 10 minutes after ignition does not exceed 60 kW/m2, when tested at 25 kW/m2, for all of the 3 samples.

### Example 7

### Resistance of Treated Timber to Wood-Borers

Wood borer are insects which damage wood by tunnelling at the larval (grub) stage for food or leaving an emergence hole on the surface of the wood after becoming an adult (beetle). These emergence holes (‘pin holes’) are quite visible and are usually the first signs of an active infestation of wood borer.

An outdoor trial was conducted between February and April on the Southern New South Wales coast to evaluate efficacy of the following composition in treating wood-borer. The composition used included about 10% Acetate, 20% Tartrate, 20% tetraborate. The sawdust treatment was applied by spraying using an adjustable nozzle spray bottle, using a fine mist spray setting. The sawdust and wood borers were placed in separate identical covered clear glass containers, with air access holes drilled in the lid covers, and were situated adjacent to each other in a shaded location. The containers were inspected weekly, and on the first and second inspection, it was observed that the wood borers having treated sawdust had retreated from that sawdust, and on the third inspection all wood borers having access only to the treated sawdust as a food source were deceased, whereas those in the adjacent container with untreated sawdust appeared to be thriving with no evident mortality.

### Example 8

### Resistance of Ceramic Tile Surface to Mould

This trial was conducted in a toilet/bathroom/shower facility on the Southern New South Wales coast during the months of February to April. A composition similar to that in Example 7 was used.

In these tests, the composition was applied using different methods on the various mould and fungi locations in the facility. Some were sprayed (using a domestic spray bottle), some painted using a small artist's brush, and some had single drops of about 0.05 ml applied using a 2.5 ml hypodermic syringe (without the needle). Also, as a comparison, some were treated in the same way using a 50:50 (about 10 gm of each in 250 ml water) mix of potassium carbonate and Potassium bicarbonate solution as these compounds are now recognised as having fungicidal and mildewicidal properties. Some were left untreated as a control.

Inspection occurred daily after application and it was observed that degradation of both the mould and the fungi was evident at 1 day for those treated with the composition, the mould and fungi becoming black. At 2 days, the fungi had collapsed and started to “dissolve”, and only a small pool remained after 3-4 days, which progressively diminished and eventually disappeared completely within 3 weeks. The carbonate/bicarbonate comparison mix achieved similar results but took much longer, i.e. about 3-4 days before blackening occurred and about 1 week to fungi collapse.

The untreated mould and fungi continued to flourish. Furthermore, there was no significant differences observed in the methods of application. The areas treated with the composition at that time remain free of mould and fungi up until the filing date of this application.

1. A composition for conferring fire retardancy on a material, the composition comprising a borate ion, a borate ion-complexing species, and a metal ion.

2. A composition according to claim 1 wherein the borate ion-complexing species forms an ionic complex with the borate ion.

3. A composition according to claim 1 wherein the borate ion is present at a concentration higher than the maximum concentration achievable in the absence of the borate ion-complexing species.

4. A composition according to claim 1 wherein the concentration of a borate salt used to provide the borate ion is between about 25 g/l and about 300 g/l.

5. A composition according to claim 1, wherein the concentration of the borate salt used to provide the borate ion is between about 50 g/l and about 200 g/l.

6. A composition according to claim 1 wherein the borate ion is a tetraborate ion.

7. A composition according to claim 1 wherein the metal ion is a Group 1A metal.

8. A composition according to claim 7 wherein the Group 1A metal is potassium.

9. A composition according to claim 8 wherein the potassium is present at a concentration of at least about 1 M.

10. A composition according to claim 1 wherein the borate-ion complexing species has at least one available hydroxyl radical.

11. A composition according to claim 1 wherein the borate ion-complexing species includes only carbon, hydrogen and oxygen atoms.

12. A composition according to claim 1 wherein the borate ion-complexing species is an organic acid or a derivative salt thereof.

13. A composition according to claim 12 wherein the organic acid is selected from the group consisting of acetic, tartaric, lactic, malic, formic, oxalic, and ascorbic acids.

14. A composition according to claim 12 wherein the organic acid is selected from the group consisting of acetic, citric, and tartaric acids.

15. A composition according to claim 1 wherein the borate-complexing species is a carbohydrate.

16. A composition according to claim 15 wherein the carbohydrate is not attractive to insects.

17. A composition according to claim 16 wherein the carbohydrate is starch.

18. A composition according to claim 1 wherein the borate ion-complexing species is present at a concentration such that the concentration of the borate is capable of being between about 25 g/l and about 300 g/l.

19. A composition according to claim 1, wherein the borate-complexing species is present at a concentration such that the concentration of borate is capable of being between about 50 g/l and about 200 g/l.

20. A composition according to claim 1 wherein the borate ion-complexing species is an acetate ion.

21. A composition according to claim 20 wherein the acetate is used in the form of a Group 1A metal salt.

22. A composition according to claim 21 wherein the Group 1A metal is potassium.

23. A composition according to claim 20 comprising the following components at the stated concentrations (% by weight)

| | |
|---|---|
| Alkali-metal acetate | 5-40 |
| Alkali-metal tetraborate | 5-30 |
| Other borate complexing species | 5-30 |

24. A composition according to claim 1 comprising a binder and/or sealant.

25. A composition according to claim 24 wherein the binder is an acrylic polymer binder.

26. A composition according to claim 25 wherein the acrylic polymer is Primal AC-2235 or equivalent.

27. A composition according to claim 26 wherein the sealant is a dendrimer.

28. A composition according to claim 27 wherein the dendrimer is readily emulsifiable by an anionic dispersant

29. A composition according to claim 28 wherein the dispersant is Ricaphob P1640 or equivalent.

30. A composition according to claim 27 wherein the dendrimer is readily emulsifiable by a cationic dispersant.

31. A composition according to claim 30 wherein the dendrimer is Ricaphob EEE or equivalent

32. A method for treating a material to confer resistance to an environmental factor comprising use a composition according to claim 1.

33. A method according to claim 32 wherein the material is a cellulose-based material.

34. A method according to claim 33 wherein the cellulose-based material is selected from the group consisting of wood, paper, cardboard, a natural fiber, and an insulation material.

35. A method according to claim 32 wherein the environmental factor is selected from the group consisting of fire, heat, combustion, an insect, a mould, a mildew, and a fungus.

36. A method for producing a composition according to claim 1, the method comprising providing a borate ion-complexing species in aqueous solution and then adding a borate ion to the solution.

37. A method according to claim 36 wherein where the final composition is includes an acetate ion, the method includes providing an acetate ion in aqueous solution, then adding to the solution a borate ion-complexing species, and then adding a borate ion to the solution.

38. A material treated by a method according to claim 32.
